(19) United States
(12) Patent Application Publication
(10) Pub. No.: US 2022/0024001 A1
(43) Pub. Date: Jan. 27, 2022

(54) FLUID CONTAINER DIFFUSER TOOL AND METHOD

(71) Applicant: DYLN Inc., Irvine, CA (US)

(72) Inventor: Dorian R. Ayres, Dripping Springs, TX (US)

(73) Assignee: DYLN Inc., Irvine, CA (US)

(21) Appl. No.: 17/382,554

(22) Filed: Jul. 22, 2021

Related U.S. Application Data
(60) Provisional application No. 63/055,702, filed on Jul. 23, 2020.

(51) Int. Cl. B25B 13/48; B25B 13/06; B25B 23/00; B25B 27/02

(52) U.S. Cl. CPC B25B 13/481; B25B 27/02; B25B 23/0021; B25B 13/06

(57) ABSTRACT

A tool adapted for use with a diffuser cartridge and a fluid container, wherein the tool is adapted to facilitate insertion and removal of the diffuser cartridge to and from the fluid container. The tool includes segments that can be separated for shipping or storage and assembled into a tool for removing and inserting a diffuser cartridge. The segments of the tool interlock using a complementary tongue and groove structures. The bottom element that engages the diffuser includes a tongue that engages a middle element having a groove. The middle element also has a tongue that engages a top element having a groove.

### CROSS-REFERENCE TO RELATED APPLICATIONS

This application claims the benefit of U.S. Provisional Application No. 63/055,702, filed Jul. 23, 2020, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to an extension tool, and more specifically, to an elongate tool adapted to facilitate insertion of a diffuser cartridge into a fluid container bottle.

### 2. Description of the Related Art

Personal hydration includes the need for portable drinking fluid containers and bottles. Because of the sustainability and environmental issues associated with plastic and single use water bottles, consumers are attracted to reusable containers as such as stainless steel water bottles. Also, stainless steel bottles can be formed to be free of BPA, lead or other toxins making for a healthier container. In addition, consumers have recognized the health benefits of treated drinking fluids such as alkaline water. In this regard, these devices have addressed the need for combining the benefits of reusable containers in combination with the easy availability of treated fluids such as alkaline water.

Alkaline water is understood to be beneficial to health for maintaining physical stability and helping to deal with acid buildup in the body in both healthy individuals and those with conditions that cause acidification of the blood. Alkaline water is said to aid in digestion, neutralize acidity, and to also assist in reducing free radicals. In addition, in most instances, alkaline water has a pH above 7.0 that has also been identified as allowing the body to more easily absorb the water. Generally, alkaline water is obtained by water electrolysis and/or through chemical treatment by mineral agents. In many related devices for creating alkaline water, electricity is used in association with an apparatus, or otherwise such devices have complex structures that are not conducive for treating drinkable fluids in a portable manner. A discussion of the types and systems for creating alkaline water are described in Chung, U.S. Publication No. 2007/0221556, published Sep. 27, 2007, the substance of which is incorporated herein by reference.

Prior devices also disclose the use of mineral agents in fluid vessels, to allow untreated water to come in contact with the agents to form alkaline water. Such prior devices however include multi-part structures that are not user friendly and may not remain fixed in a vessel, as intended, or otherwise use an undesirable amount of volume within a vessel and do not facilitate the flow of water around the mineral agents. As such, devices have been developed to address the need for the worry-free use of a reactive agent in a portable fluid vessel, that does not overtake the functional use of the vessel and which does not use an undesirable amount of volume of the bottle. Also, fluid bottles having a structure where a diffuser may be attached to the base of the bottle is shown and described in: Ayres, U.S. Pat. No. 9,688,445 entitled FLUID CONTAINER WITH INTERNAL PERFORATED COMPARTMENT, issued Jun. 27, 2017; and Ayres, U.S. Publication No. 2020/0107667 entitled CONTOURED DOUBLE WALLED FLUID CONTAINER WITH INTERNAL COMPARTMENT, published Apr. 9, 2020 the substance of each of which are incorporated herein by reference in their entirety.

Furthermore, many fluid vessels are shaped to include a closed end portion and an open-end portion formed at a narrow neck of the fluid vessel. The narrow configuration of the fluid vessel and the depth of the bottle may make it difficult to insert the structures associated with the mineral agents into the fluid vessel. One solution is disclosed and described in Ayres, U.S. Publication No. 2017/0173769 entitled FLUID CONTAINER DIFFUSER SYSTEM AND RELATED METHOD OF USE, published Jun. 22, 2017, the substance of which is incorporated herein by reference in its entirety. As such there is a need for an implement that effectively allows for insertion, attachment and removal of a diffuser element into a vessel body.

### BRIEF SUMMARY

In accordance with the present disclosure, there is provided a tool adapted for use with a diffuser cartridge and a fluid container, wherein the tool is adapted to facilitate insertion and removal of the diffuser cartridge to and from the fluid container. The tool may comprise selectively detachable sections that are easily and securely attached together to provide an extended reach into the bottle for insertion and removal of a diffuser cartridge. The diffuser cartridge may contain mineral agent beads or other materials which can enhance the quality or chemical make up of fluid contained within the container.

According to one embodiment, the tool is adapted for use with a diffuser cartridge and a fluid containment vessel wherein the containment vessel has a base and a retaining wall coupled to the base for engaging and disengaging with a diffuser cartridge. The vessel has an upper rim around an opening and the upper rim and the base define a vessel height. The diffuser cartridge is detachably engageable with the retaining wall to assume a nested configuration within the vessel. The tool includes a bottom segment having a first end portion complementary in shape to the diffuser cartridge and adapted to be selectively engageable with the diffuser cartridge, and a second end portion having a bottom segment connector that has a protruding tongue. The tool further includes an intermediate segment separate from the bottom segment and having a groove adapted to engage with the bottom segment protruding tongue, and a second intermediate connector having a protruding tongue. The tool additionally comprises a top segment separate from the bottom segment and intermediate segment, with the top segment having a top segment groove adapted to engage with the protruding tongue. The intermediate segment is connected to the bottom segment and the top segment when the tool is in an assembled configuration, with the tool being sized and configured such that an end surface of the diffuser cartridge and a portion of the top segment of the tool collectively define an operating length greater than the vessel height. The disclosure contemplates that the top segment may be attached a bottom segment, so that the tool is operable with two segments.

The bottom segment may include a cavity adapted to receive a portion of the diffuser cartridge when the first end portion of the bottom segment is engaged with the diffuser cartridge. The bottom segment may also include a channel formed in the inner cavity, adapted to receive a portion of the diffuser cartridge to effectuate engagement between the bottom segment and the diffuser cartridge. The channel may include an axial segment and a radial segment.

The tool includes segments that can be separated for shipping or storage and assembled into a tool for removing and inserting a diffuser cartridge. The separated segments are able to collectively fit within the vessel with the vessel cap secured. The segments of the tool interlock and detach using a complementary tongue and groove structures. The bottom segment or element that engages the diffuser includes a tongue that engages a middle segment or element having a groove. The middle segment or element also has a tongue that engages a top segment or element having a groove. The top segment or element may include an enlarged end portion opposite the top segment or element connector, with the enlarged end portion being sized and configured to be gripped by the user. It is contemplated by this disclosure that the bottom segment tongue may engage the groove of the top segment so that the tool may operable using the top and bottom segments without the intermediate segment. As used throughout this disclosure may use the terms segment and element may be used interchangeably.

The tool may be sized and configured to extend from the diffuser cartridge and beyond the upper rim of the fluid containment vessel when the first end portion is engaged with the diffuser cartridge.

The bottom segment, intermediate segment and top segment may be formed from a plastic material. The intermediate segment and portions of the top and bottom segments may each define an outer diameter substantially equal to each other.

The tool may be formed of a plurality of interconnectable elements, which when connected, define a length that is long enough to allow the user to insert or remove the diffuser cartridge from the fluid container while the user's hand remains outside of the container. As such, the user is not required to squeeze his or her hand through the narrowing opening commonly associated with such fluid containers. The tool and the use thereof allows for the attachment of the diffuser to the bottom of the vessel without the need to have a mechanism for accessing or opening the bottom of the vessel. Adapting a fluid vessel to have a bottom opening increases cost of manufacture and increases the complexity of use, among other issues. Also, having the diffuser located at the bottom of the vessel aids in increasing the amount of contact of diffuser ingredients will have with the liquid, as opposed to situating the diffuser in the container lid, for example, where liquid may not contact a diffuser when the container is less than completely full.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective, partial cutaway view showing a first embodiment of the tool engaged with a diffuser cartridge, with the diffuser cartridge being engaged with the vessel body;

FIG. 2 is a side view of the first embodiment of the tool with segments assembled;

FIG. 3 is an exploded view of the first embodiment of the tool with the segments separated;

FIG. 4 is a lower perspective view of the first embodiment of the assembled tool;

FIG. 5 is an exploded lower perspective view of the first embodiment of the tool with the segments separated;

FIG. 6 is a cross sectional view of the joint of two connected segments along line 6-6 of FIG. 2;

FIG. 7 is a cut away view of a female receiving groove of a segment of the various embodiments of the tool;

FIG. 8 is a cut away view of a male tongue of a segment of the various embodiments of the tool;

FIGS. 9-11 show a sequence of connecting the tool to the diffuser cartridge and removing the diffuser cartridge from the vessel using the first embodiment of the tool;

FIG. 12 is a cross sectional view of a vessel with a reduced height wherein the first embodiment of the tool is assembled using the top and bottom segments of the tool;

FIG. 13 is a top perspective view of the top segment of the first embodiment of the tool;

FIG. 14 is an exploded view showing the top segment of the first embodiment of the tool shown in FIG. 13, with a handle top separated;

FIG. 15 is a cross sectional view along the lines 15-15 of FIG. 14;

FIG. 16 is a cross sectional view of the assembled top segment of the tool shown in FIG. 13;

FIG. 17 is an exploded side view of a second embodiment of the tool;

FIG. 18 is an exploded side view of a third embodiment of the tool; and

FIG. 19 is an exploded view of a fourth embodiment of the tool.

Common reference numerals are used throughout the drawings and the detailed description to indicate the same elements.

### DETAILED DESCRIPTION

The detailed description set forth below in connection with the appended drawings is intended as a description of certain embodiments of a tool for inserting a diffuser cartridge into a fluid containment vessel, such as a water bottle, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

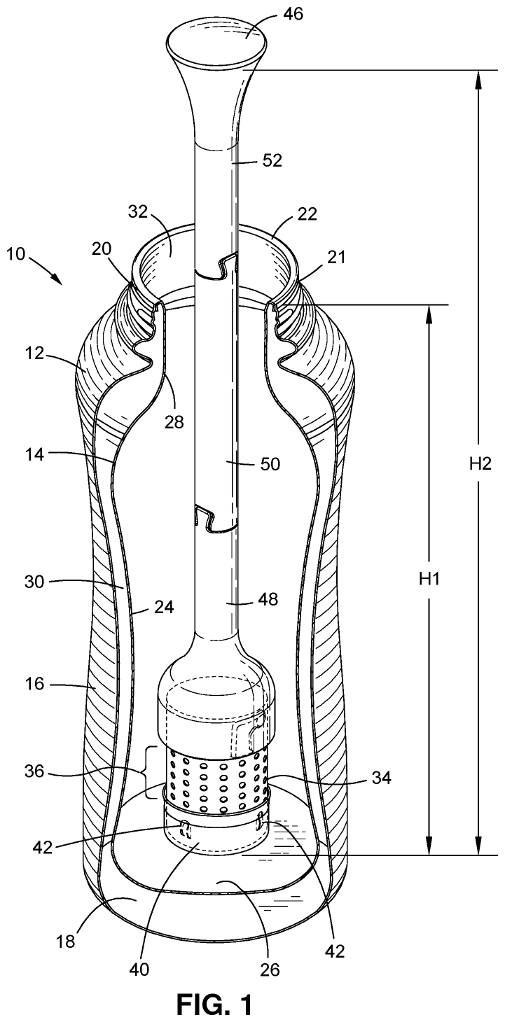

Referring now to FIG. 1, there is shown a fluid containment vessel (e.g., container) 10 including an outer vessel body 12 and an inner vessel body 14. The outer vessel body 12 is formed from an elongate stainless-steel sidewall 16 and a base 18, with the sidewall 16 being tapered at a neck portion 20. The neck portion 20 terminates at an upper rim 22. The inner vessel body 14 is formed from an elongate stainless-steel inner sidewall 24 and an inner base 26, with the inner sidewall 24 being tapered at an inner neck portion 28. The inner neck portion 28 terminates at an upper rim 22. The inner vessel body 14 and the outer vessel body 16 for an inner void 30 that provides a mechanism to reduce heat transfer between the inner body 14 and outer body 16 and may include a vacuum, or air, or other suitable gas. The inner vessel body 14 having a first height H₁ equal to the distance between the base 26 and the upper rim 22. A user can selectively open and close the container 10 by securing a cap (not shown) to the outer vessel body 12 at the neck portion 20 using threads 21 formed into the neck portion 20.

The outer sidewall 16 and inner sidewall 24 are disposed about a central axis extending from the center of the outer base 18 and the center of the of the opening 32 formed by the neck portion 20 and rim 22. The opening 32 provides an inlet for which fluid can be inserted or extracted from the inner vessel body 14 and is wide enough to promote drinking directly from the vessel 10. In addition, it is contemplated that an insulating material or substance may be disposed between the outer sidewall 16 and inner sidewall 24 to fill void 30.

A diffuser cartridge 34 is detachably affixable/engageable to the inner base 26 and is adapted to have mineral agent beads (not shown) or other materials contained within the cartridge 34 that can interact with and treat a fluid contained within the inner vessel body 14. Mineral agent beads or the like are secured within the cartridge 34 so as not to escape from the cartridge 34 and into the void of the inner vessel body 14. The exemplary cartridge 34 is of a cylindrical shape, although those skilled in the art will readily appreciate that the cartridge 34 may take on other shapes including, but not limited to a spherical shape, a cuboid shape, or any other shapes.

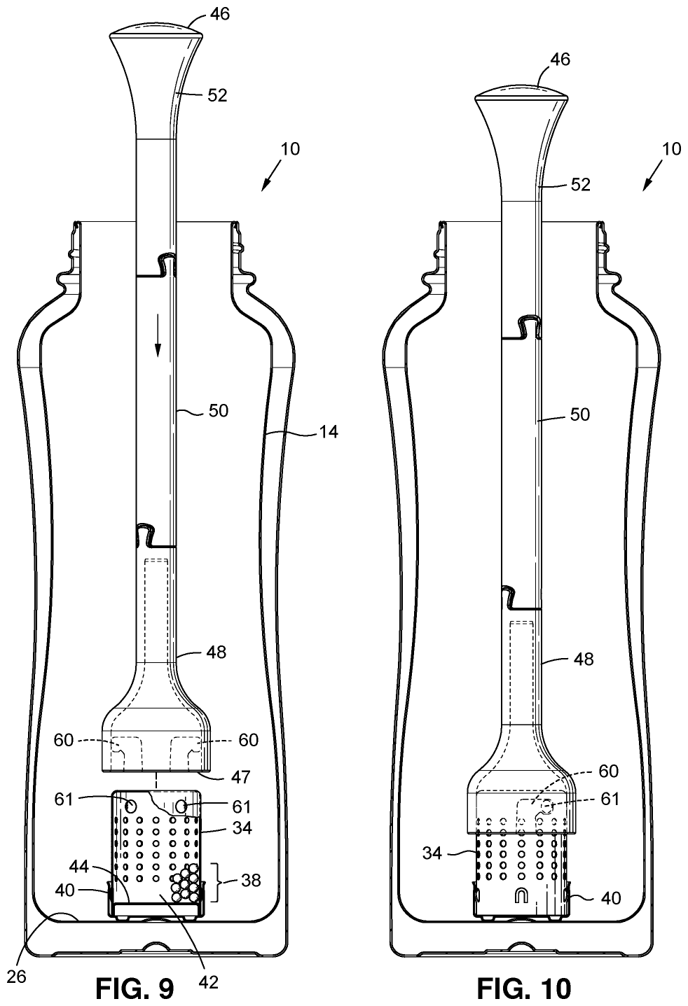

The cartridge 34 includes a plurality of perforations 36 formed therein, with the perforations 36 being sized relative to the mineral beads 38 (see FIG. 9 in cutaway of cartridge 34) so as to retain the mineral beads 38 within the cartridge 34, while at the same time allowing the beads to be bathed within the water/fluid contained within the inner vessel body 14. The perforations 36 shown in the drawings are arranged in rows and columns, although the perforations 36 may be formed on the cartridge 34 in any arrangement or pattern. The cartridge 34 being cylindrically shaped depicted in the Figures according to one embodiment defines an outer diameter preferably between 0.5-2.0 inches, and more preferably equal to approximately 1.125 inches. Furthermore, in one embodiment the height of the cartridge 34 is preferably between 1.0-3.0 inches, and more preferably equal to approximately 1.6875 inches.

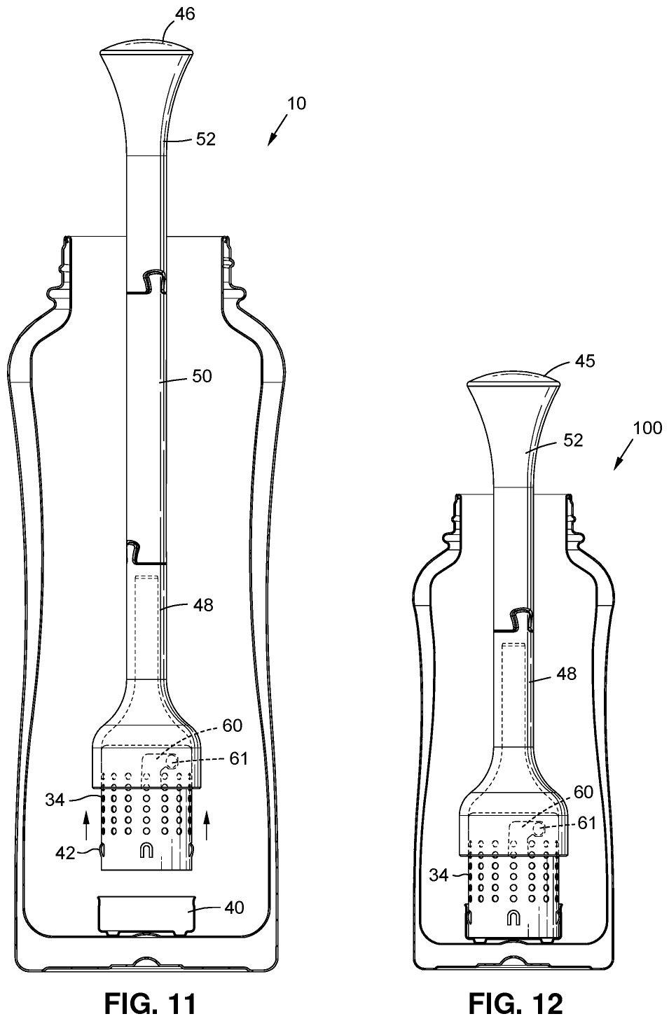

The cartridge 34 is adapted to engage with a retaining wall 40, which extends around a retaining cavity (not shown) and is coupled to the inner base 26 of the container 10. The retaining wall 40 and corresponding retaining cavity are complementary in shape to the cartridge 34 to allow the cartridge 34 to be selectively nested within the retaining cavity 32 and engaged with the retaining wall 40 to affix the cartridge 34 to the inner vessel body 14 at inner base 26. The cartridge 34 and the retaining wall 40 are configured to become sufficiently engaged with each other when the cartridge 34 is nested within the retaining cavity so as to hold the cartridge 34 in the nested position as the user repeatedly tips the container 10 to drink the water or other liquid contained therein. In this regard, the cartridge 34 and the retaining wall 40 may be adapted to create such engagement via a friction-tight fit, spring-type tabs, locking rims, or threaded engagement or other like structures. In the embodiment shown in the figures the cartridge 34 employs spring tabs 42 shown in broken line in FIG. 1 and also shown in FIG. 11.

FIG. 9 shows is a cut away view of the cartridge 34 engaged with the raining wall 40 shown in cross section. In the embodiment depicted in FIG. 9, the retaining wall 40 includes plate 44, with the annular retaining wall 40 extending upwardly from the bottom plate 44. The bottom plate 44 is connected to the inner base 26 of the inner vessel body. The generally bottom planar surface of the bottom plate 44 is placed in opposed relation to a planar surface of the inner base 26. The bottom plate 44 may be attached to the inner base 26 via welding, an adhesive, or other mechanical joining techniques known by those skilled in the art. For more information pertaining to a structure of diffuser cartridge 34 and attachment to the base of a fluid vessel, please refer to Ayres, U.S. Pat. No. 9,688,445 entitled FLUID CONTAINER WITH INTERNAL PERFORATED COMPARTMENT, issued Jun. 27, 2017 and Ayres, U.S. Publication No. 2020/0107667 entitled CONTOURED DOUBLE WALLED FLUID CONTAINER WITH INTERNAL COMPARTMENT, published Apr. 9, 2020 the contents of which are expressly incorporated herein by reference in their entireties.

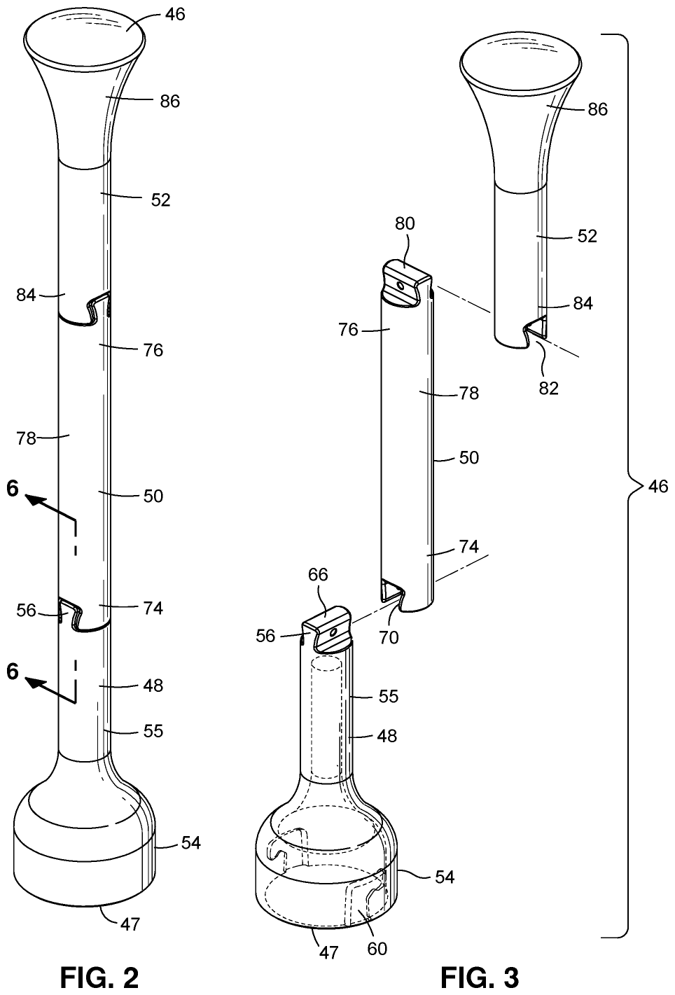

The following discussion will focus on the structure and use of a specifically configured tool 46, as shown in FIGS. 2-8 used for inserting the diffuser cartridge 34 into the inner vessel body 14, and subsequently removing the diffuser cartridge 34 from the inner vessel body 14. The tool if formed from a food grade plastic material such as Acrylonitrile butadiene styrene (ABS) or any other suitable thermoplastic polymer. According to one embodiment, the tool 46 is elongate and is formed from a plurality of separate tool elements, including a bottom element 48, and intermediate element 50, and a top element 52. The tool 46 is configured such that the tool 46 may be manually manipulated or held by an individual to insert or remove the diffuser cartridge 34 to or from the inner vessel body 14, with the tool 46 being configured to allow an individual's hand to remain outside of the inner vessel body 14 throughout the insertion or removal process. In this respect, the tool 46 and diffuser cartridge 34 collectively define a height H2 (as shown in FIG. 1) which is larger than the height H₁ of the inner vessel body 14, which allows a portion of the tool to extend beyond the upper rim 22 of the inner vessel body 14 when the tool 46 is engaged with the diffuser cartridge 34, and with the diffuser cartridge 34 nested within the retaining wall 40.

The bottom element 48 includes a first end portion 54 adapted to interface with the diffuser cartridge 34 and a second end portion 56 adapted to interface with the intermediate element 50. The first end portion 54 includes a cylindrical wall disposed about a cavity 58, with the cylindrical wall terminating at a distal end 47 of the tool 46. The cavity 58 is adapted to receive the diffuser cartridge 34, with the inner diameter of the cylindrical wall of end portion 54 being slightly larger than the outer diameter of the diffuser cartridge 34. A pair of diametrically opposed recesses 60 are formed on the inner surface of the cylindrical wall of the end portion 54 from the distal end 47 of the tool 46, with each recess 60 having an axial segment 62 and a radial segment 64. The axial segment 62 extends from the distal end 47 and the radial segment 64 is spaced from the distal end 47. The dimension of the recesses 60 corresponds to a pair of diametrically opposed nubs or protrusions 61 formed on the diffuser cartridge 34. In particular, the recesses 60 are configured such that each nub 61 (as shown in FIGS. 9-11) may be received within a respective recess 60 to operatively couple the bottom element 48 to the diffuser cartridge 34. A protrusion 61 is received into the axial segment 62 of a recess 60, and upon manual turning of tool 46, is received into the radial segment 64 of a recess 60 forming an engagement of the cartridge 34 to the bottom element 48 of the tool 46.

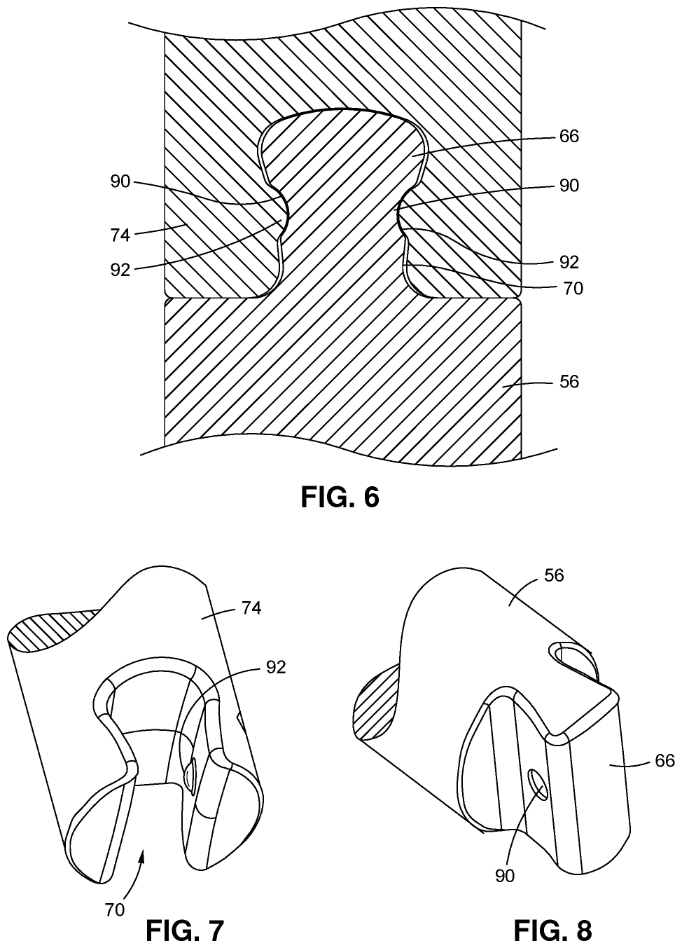

The second end portion 56 of the bottom element 48 is interconnected to the first end portion 54 via an intermediate elongate segment 55, which has a smaller diameter than the cylindrical wall of the first end portion 54. The second end portion 56 includes a tapered tongue 66 shown in detail in FIGS. 6 and 8. The tongue 66 is sized and adapted to be received within a corresponding groove 70 formed in the first end portion 74 of the intermediate element 50. The intermediate element 50 includes a first end portion 74 and a second end portion 76 and an intermediate segment 78 disposed therebetween. The first end portion 74 is adapted to interface with the bottom element 48 and the second end portion 76 is adapted to interface with the top element 52. In the disclosure shown, the first end portion 74 defines a groove 70 adapted to engage with the tongue 66 of the bottom element 48, while the second end portion 76 defines a tongue 80 adapted to engage with a groove 82 formed in the top element 52. It is understood that the tongue 66 of the bottom segment 48 may equally interface with the groove 82 of the top segment 52.

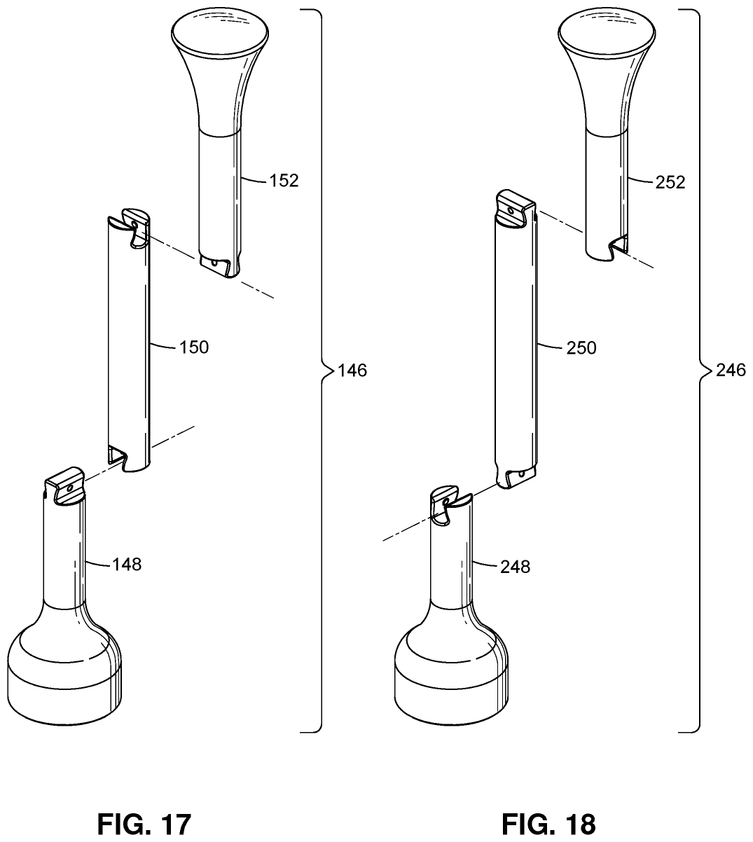

Referring particularly to FIGS. 6-8, there is shown the tongue and groove elements for interconnecting the various segments of tool 46. FIGS. 6-8 depict the tongue 66 interfacing with groove 70 of the second end portion 56 of bottom element 48 with the groove 70 of the first end portion 74 of the intermediate element 50. It should be noted however, that the features shown in FIGS. 6-8 could also depict the tongue 80 and groove 82 elements of the intermediate segment 50 interfacing with the top element 52, respectively, as the structures are identical, and could equally depict tongue 66 interfacing with groove 82, as discussed with regard to FIG. 11. As depicted in the exploded views of FIGS. 3 and 5, tongue 66 would be received laterally into groove 70, as the top of tongue 66 has a larger width than the base of tongue 66 where it is formed to second end 56. Likewise, the complementary shape of groove 70 is narrower at the opening than at the inner recess and as such, the groove 70 may only receive the tongue 66 laterally to interlock similar to a puzzle piece. As shown in FIGS. 3 and 5 and with respect to the additional embodiments of FIGS. 17-19, the lateral axis of the groove and tongue alignment of the connection between the bottom segment with the intermediate segment is positioned perpendicular to the lateral axis of the grove and tongue alignment of the connection between the top segment and intermediate segment. The perpendicular placement of the lateral alignment between sections provides additional stability when the tool is assembled and likewise aids in maintaining the interconnection of the segments when the tool receives rotational forces when inserting and removing the cartridges 34. FIG. 6 shows the interlocked tongue 66 with the groove 70 shown as a cross section of FIG. 2 along axis 6-6. The tongue 66 includes recesses 90 formed on each side of the tongue 66 to receive corresponding protrusions 92 formed into each side of the interior of the groove 70. As such, when engaged, the tongue 66 and groove 70 are snap fit into place by the engagement of the protrusions 92 into the recesses 90 to provide additional stability and tight fit between the elements. Also, since the elements of the tongue and groove are engaged laterally, the protrusions 92 and the recesses 90 aid in preventing lateral slippage of the tongue 66 within the groove 70. It is contemplated by this disclosure that the protrusion 92 could be positioned on the tongue 66, and the recess 90 formed in the groove 70 in reverse fashion so provide the additional stability in tight fit between the elements as an alternative structure.

The top element 52 includes a first end portion 84 and a second end portion 86. The first end portion 84 defines a groove 82 adapted to interface with the intermediate element 50 at the second end portion 76 via the tongue 80. The cylindrical wall of the top element 52 transitions into the second end portion 86, which includes an outwardly tapering wall to provide an ergonomically friendly gripping portion. The top element 52 including end portion 86 may be constructed of solid ABS or like plastic forming a unitary structure without any interior voids.

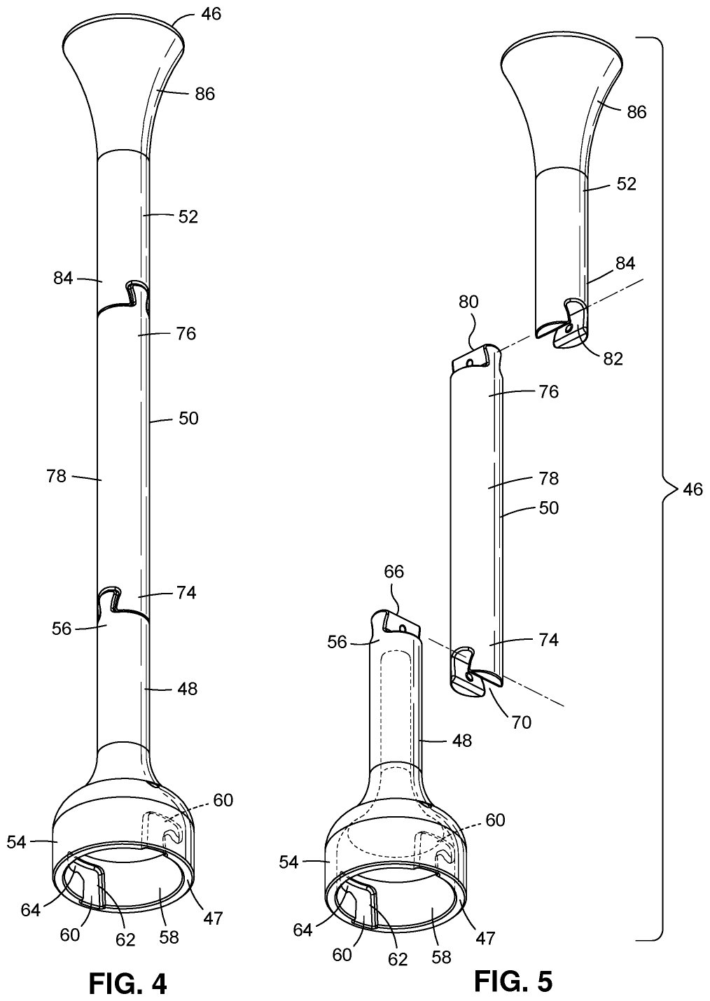

With the structure of the tool 46 described above, the following discussion will focus on usage of the tool 46 as shown in FIGS. 9-11. To insert the diffuser cartridge 34 into the inner vessel body 14, a user would first assemble the tool 46 by connecting the first end portion 74 of the intermediate element 50 to the bottom element 48 and the second end portion 76 of the intermediate element 50 to the top element 52. Once the tool 46 is assembled, the user attaches the diffuser cartridge 34 to the tool 46 by aligning the recesses 48 formed on the bottom element 48 with the protrusions or nubs 61 formed on the diffuser cartridge 34. The user then advances the tool 46 over the cartridge 34, which causes the protrusions or nubs 61 to pass through the axial segments 62 of the corresponding recesses 60 (see FIG. 4). The user then rotates the tool 46 a first direction to allow the nubs 61 to pass through the radial segments 64 of the corresponding recesses 60. Once the nubs 61 pass through both the axial 62 and radial segments 64, the diffuser cartridge 34 is attached to the tool 46.

The diffuser cartridge 34 is then inserted into the inner vessel body 14 by holding the tool 46 at the top element 52 and aligning the diffuser cartridge 34 and bottom element 48 of the tool 46 with the opening 32 of the inner vessel body 14. The user lowers the tool/cartridge assembly into the vessel body 12 until the diffuser cartridge 34 reaches the retaining wall 40. When the diffuser cartridge 34 is aligned with the retaining wall 40, the user presses/pushes the tool 46 therein until the diffuser cartridge 34 is nested within retaining wall 40. Once the diffuser cartridge 34 is secured/nested within the cavity of the retaining wall 40, the user rotates the tool 46 in a second direction opposite to the first direction, which causes the nubs 61 to retreat back through the radial segments 64 of the recesses 60 formed in the bottom element 48. The user then lifts the tool 46, which causes the nubs 54 to retreat through the axial segments 62, which ultimately allows the tool 46 to become disengaged from the diffuser cartridge 34. The tool 46 is then completely removed from the inner vessel body 14, and the user may continue using the container 10 with the diffuser cartridge 34 secured therein.

To remove the diffuser cartridge 34, the user again assembles the tool 46, as described above, if the tool 46 is disassembled. The assembled tool 46 is then inserted into the inner vessel body 14 until the bottom element 48 reaches the diffuser cartridge 34. The user then rotates the tool 46 to align the recesses 60 with the nubs 61. Once the nubs 61 are aligned, the user presses down to allow the nubs 61 to pass through the axial segment 62, and then rotates the tool 46 in the first direction to allow the nubs 61 to pass through the radial segment 64, and ultimately, secure the tool 46 to the diffuser cartridge 34. The user then holds the vessel body 12 in one hand, and pulls on the tool 46 to overcome the engagement force holding the diffuser cartridge 34 to the retaining wall 40, thereby releasing the diffuser cartridge 34 from the retaining wall 40. The user then pulls the tool/cartridge assembly from the inner vessel body 14 until the tool 46 and diffuser cartridge 34 are completely removed from the inner vessel body 14.

Referring to FIG. 12 there is a shown a bottle 100 that employs a diffuser cartridge system identical to the bottle shown in FIG. 1, except that the dimensions of the depth of bottle 100 is more shallow than the bottle shown in FIG. 1. FIG. 12 demonstrates that the top element 52 can interlock with bottom element 48 and operate as a tool that excludes the intermediate element.

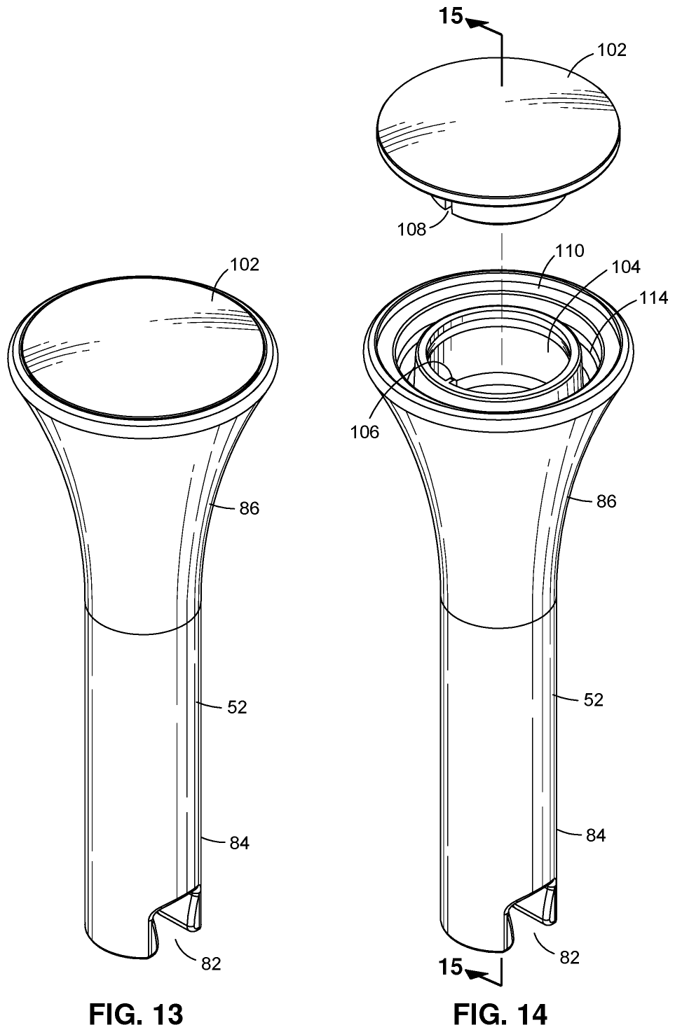

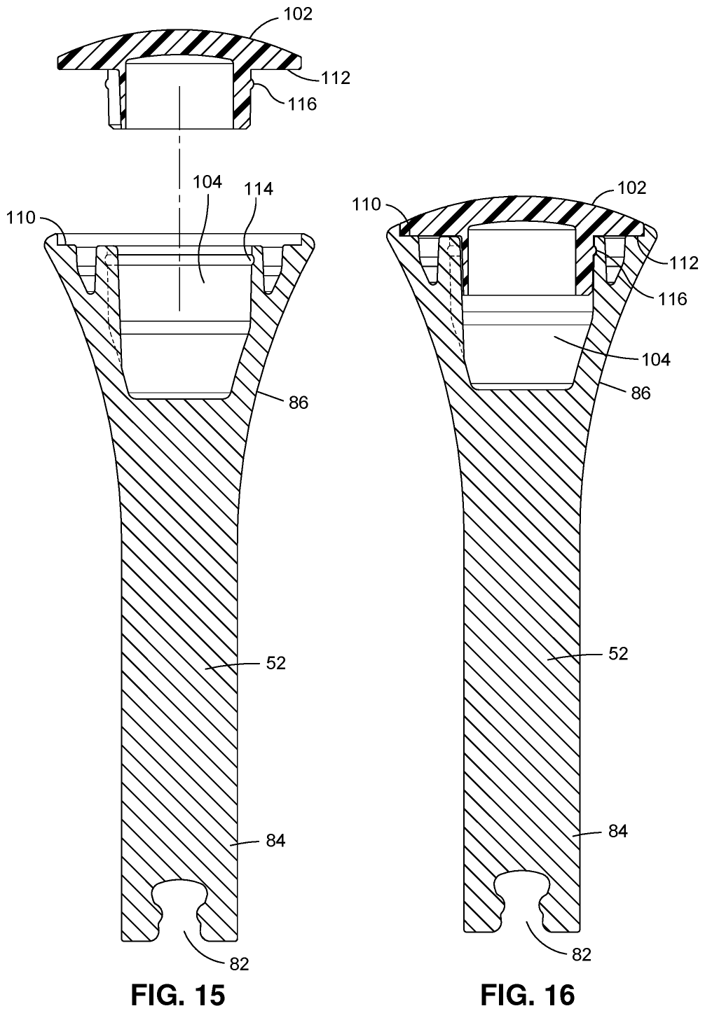

Referring to FIGS. 13-16 there is shown an example of a particular construction of top element 52 which is not formed from a solid piece of ABS. The top element 52 is formed having a first end 84 defining a groove 82 and a tapered second end 86 having an increasing diameter forming an ergonomic handle. The tapered second end 86 has a void 104 is formed therein having interior sidewalls and having an opening for receiving a top cap 102. Within the void 104 a lip 110 is formed around the perimeter of the opening of the void 104 to engage bottom surface 112 of the top cap 102. A circular recess 114 is formed in the sidewall of the void 104 to engage a rim 116 formed in the sidewall extending downwardly from the center of the cap 102. A guide 106 is formed extending from the sidewall of the void 104 to mate with a recess 108 formed in the sidewall of the base of the cap 102 extending from the center of the top cap 102 for proper positioning the top cap 102 when inserted into the void 104. Sidewalls of the void 104 in conjunction with the rim 116 and recess 114 provide a friction or snap fit of the cap 102 into the void 104 forming a finished rounded top surface of the cap 102 when inserted within the void 104. The cap 102 may be formed of ABS or similar plastic but may also be formed of silicon or rubber.

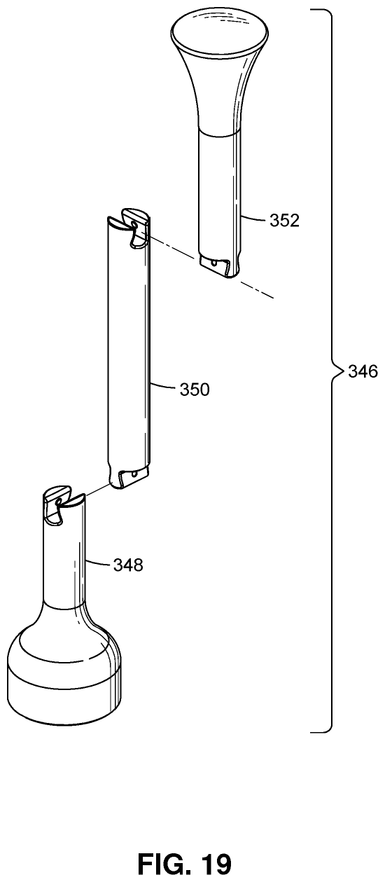

Referring to FIGS. 17-19 are shown further embodiments of the tool 46, wherein the interlocking tongue and groove components are positioned differently on the various segments. Referring to FIG. 17, the tool 146 has a bottom segment 148 with a tongue formed thereon, and a top segment 152 with a tongue formed thereon. The intermediate segment 150 has grooves formed on each end, and are adapted to receive both the tongues of the top 152 and bottom 148 segments. Referring to FIG. 18, the tool 246 has a bottom segment 248 with a groove formed thereon, and a top segment 252 with a groove formed thereon. The intermediate segment 250 has tongues formed on each end, and are adapted to be received by both the grooves of the top 252 and bottom 548 segments. Referring to FIG. 19, the tool 346 has a bottom segment 348 with a groove formed thereon, and a top segment 352 with a tongue formed thereon. The intermediate segment 350 has a tongue formed on a first end where the tongue is adapted to be received by the groove of the bottom segment 348. The second end of intermediate segment 350 has a groove formed to receive the tongue of the top segment. Due to the bottom segment 348 and top segment 352 having complementary tongue and groove arrangement, bottom 348 and top 352 segments can be directly attached for a two segment configuration similar to the two segment configuration as shown in FIG. 12.

The particulars shown herein are by way of example only for purposes of illustrative discussion and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A tool adapted for use with a diffuser cartridge and a fluid containment vessel comprising:
a bottom segment having:
a first end portion complementary in shape to a diffuser cartridge and adapted to be selectively engageable with the diffuser cartridge; and
a second end portion having a connector tongue;
an intermediate segment having:
a first end portion having a connector groove adapted to releasably engage with the connector tongue of the bottom segment; and
a second end portion having connector tongue;
a top segment having:
a first end portion having a connector groove adapted to releasably engage with the connector tongue of the intermediate segment; and
a second end portion having a handle;
wherein attachment of the bottom segment to the intermediate segment and the intermediate segment to the top segment places the tool in an assembled configuration.

2. The tool recited in claim 1, wherein the bottom segment includes a cavity adapted to receive a portion of the diffuser cartridge when the first end portion of the bottom segment is engaged with the diffuser cartridge.

3. The tool recited in claim 1, wherein the bottom segment includes a recess adapted to receive a portion of the diffuser cartridge to effectuate engagement between the bottom segment and the diffuser cartridge.

4. The tool recited in claim 3, wherein the channel includes an axial segment and a radial segment.

5. The tool recited in claim 1, wherein the top segment includes an enlarged end portion opposite the top segment connector.

6. The tool recited in claim 1, wherein the bottom segment, intermediate segment and top segment are formed from a plastic material.

7. The tool recited in claim 1, wherein the intermediate segment and portions of the top and bottom segments each define an outer diameter substantially equal to each other.

8. The tool recited in claim 1, wherein the top segment, intermediate segment and the bottom segment are selectively transitional between a disengaged configuration, wherein the top segment, bottom segment and intermediate segment segments are detached from each other, and an assembled configuration wherein the top segment, bottom segment and intermediate segment are attached to each other.

9. The tool recited in claim 1 wherein the connector tongue of the bottom segment has a recess formed in the tongue and the connector groove of the intermediate segment has a protrusion formed in the connector groove wherein the protrusion is receivable into the recess formed in the connector tongue of the bottom segment.

10. The tool recited in claim 1 wherein the connector tongue of the intermediate segment has a recess formed in the tongue and the connector groove of the top segment has a protrusion formed in the connector groove wherein the protrusion is receivable into the recess formed in the connector tongue of the intermediate segment.

11. The tool recited in claim 1 wherein the connector tongue of the bottom segment has a protrusion formed on the tongue and the connector groove of the intermediate segment has a recess formed in the connector groove wherein the protrusion is receivable into the recess formed in the connector grove of intermediate segment.

12. The tool recited in claim 1 wherein the connector tongue of the intermediate segment has a protrusion formed on the tongue and the connector groove of the top segment has a recess formed in the connector groove wherein the protrusion is receivable into the recess formed in the connector groove of the top segment.

13. A tool adapted for use with a diffuser cartridge and a fluid containment vessel comprising:
a bottom segment having:
a first end portion complementary in shape to a diffuser cartridge and adapted to be selectively engageable with the diffuser cartridge; and
a second end portion having a connector groove;
an intermediate segment having:
a first end portion having a connector tongue adapted to releasably engage with the connector groove of the bottom segment; and
a second end portion having connector groove;
a top segment having:
a first end portion having a connector tongue adapted to releasably engage with the connector groove of the second end portion of the intermediate segment; and
a second end portion having a handle;
wherein attachment of the bottom segment to the intermediate segment and the intermediate segment to the top segment places the tool in an assembled configuration.

14. The tool recited in claim 23 wherein the connector tongue of the first portion of the intermediate segment has a recess formed in the tongue and the connector groove of the second end portion of the bottom segment has a protrusion formed in the connector groove wherein the protrusion is receivable into the recess formed in the connector tongue of the first end portion of the intermediate segment.

15. The tool recited in claim 13 wherein the connector tongue of the top segment has a recess formed in the tongue and the connector groove of the second end portion of the intermediate segment has a protrusion formed in the connector groove wherein the protrusion is receivable into the recess formed in the connector tongue of the top segment.

16. The tool recited in claim 13 wherein the connector tongue of the first portion of the intermediate segment has a protrusion formed on the tongue and the connector groove of the second end portion of the bottom segment has a recess formed in the connector groove wherein the protrusion is receivable into the recess formed in the connector groove of the second end portion bottom segment.

17. The tool recited in claim 13 wherein the connector tongue of the top segment has a protrusion formed on the tongue and the connector groove of the second end portion of the intermediate segment has a recess formed in the connector groove wherein the protrusion is receivable into the recess formed in the connector groove of the second end portion of the intermediate segment.

18. A tool adapted for use with a diffuser and fluid containment vessel comprising:
a plurality of connector segments comprising:
a bottom segment comprising:
a first end portion complementary in shape to a diffuser cartridge and adapted to be selectively engageable with the diffuser cartridge; and;
a second end portion comprising a connector tongue;
a top segment comprising:
a first end portion having a connector groove adapted to releasably engage with the connector tongue of the second end portion of the bottom segment; and
a second end portion having a handle;
wherein attachment of the bottom segment to the top segment places the tool in an assembled configuration.

19. The tool recited in claim 18 wherein the connector tongue of the bottom segment has a recess formed in the tongue and the connector groove of the top segment has a protrusion formed in the connector groove wherein the protrusion is receivable into the recess formed in the connector tongue of the bottom segment.

20. The tool recited in claim 18 wherein the connector tongue of the bottom segment has a protrusion formed on the connector tongue and the connector groove of the top segment has a recess formed in the connector groove wherein the protrusion is receivable into the recess formed in the connector groove of the top segment.

21. A tool adapted for use with a diffuser and fluid containment vessel comprising:
a plurality of connector segments comprising:
a bottom segment comprising:
a first end portion complementary in shape to a diffuser cartridge and adapted to be selectively engageable with the diffuser cartridge; and;
a second end portion comprising a connector groove;
a top segment comprising:
a first end portion having a connector tongue adapted to releasably engage with the connector groove of the second end portion of the bottom segment; and
a second end portion having a handle;
wherein attachment of the bottom segment to the top segment places the tool in an assembled configuration.

22. The tool recited in claim 21 wherein the connector tongue of the top segment has a recess formed in the tongue and the connector groove of the bottom segment has a protrusion formed in the connector groove wherein the protrusion is receivable into the recess formed in the connector tongue of the top segment.

23. The tool recited in claim 21 wherein the connector tongue of the top segment has a protrusion formed on the connector tongue and the connector groove of the bottom segment has a recess formed in the connector groove wherein the protrusion is receivable into the recess formed in the connector groove of the bottom segment

24. A tool adapted for use with a diffuser cartridge and a fluid containment vessel comprising:
a bottom segment having:
a first end portion complementary in shape to a diffuser cartridge and adapted to be selectively engageable with the diffuser cartridge; and
a second end portion having one of a connector tongue or connector groove;
an intermediate segment having:
a first end portion having one of a connector groove or connector tongue adapted to releasably engage with the connector tongue or the connector groove of the bottom segment; and
a second end portion having one of a connector tongue or connector groove;
a top segment having:
a first end portion having one of a connector groove or connector tongue adapted to releasably engage with the connector tongue or connector groove of the second end portion of the intermediate segment; and
a second end portion having a handle;
wherein attachment of the bottom segment to the intermediate segment and the intermediate segment to the top segment places the tool in an assembled configuration.
